(19) United States
(12) Patent Application Publication
(10) Pub. No.: US 2025/0216998 A1
(43) Pub. Date: Jul. 3, 2025

(54) INFORMATION PROMPT METHOD AND DEVICE

(71) Applicant: Lenovo (Beijing) Limited, Beijing (CN)

(72) Inventor: Longfei LIU, Beijing (CN)

(21) Appl. No.: 18/999,694

(22) Filed: Dec. 23, 2024

(30) Foreign Application Priority Data
Dec. 29, 2023 (CN) 202311862404.7

(51) Int. Cl. G06F 3/0481; G06F 3/0484; G06F 9/451

(52) U.S. Cl. CPC G06F 3/0481; G06F 3/0484; G06F 9/451

(57) ABSTRACT

An information prompt method includes: in response to a configuration operation acting on a first configuration item of an electronic device, updating an interface parameter of a target configuration interface of the electronic device to prompt the configuration item acted upon by the configuration operation. The target configuration interface includes a configuration interface where the first configuration item is located and/or a configuration interface where a second configuration item is located, and the second configuration item is an upper-level configuration item of the first configuration item.

### CROSS-REFERENCE TO RELATED APPLICATION

This application claims priority to Chinese Patent Application No. 202311862404.7, filed on Dec. 29, 2023, the entire content of which is incorporated herein by reference.

### TECHNICAL FIELD

The present disclosure generally relates to the field of computer technology, and, more particularly, to an information prompt method and device.

### BACKGROUND

After a computer device is turned on, a configuration interface containing several configuration items can be displayed on a display screen. When the configuration interface is displayed, the computer device can obtain a user's configuration operation on the configuration items through an input module, and adjust the configuration items based on the configuration operation, thereby meeting the user's need to adjust the device configuration.

When displaying the configuration interface, the current computer device only displays the configuration items and the current status or value of the configuration items, which cannot meet the user's need to distinguish between configuration items affected by the configuration operation and configuration items not affected in a specific usage scenario.

### SUMMARY

One embodiment of the present disclosure provides an information prompt method, including: in response to a configuration operation acting on a first configuration item of an electronic device, updating an interface parameter of a target configuration interface of the electronic device to prompt the configuration item acted upon by the configuration operation. The target configuration interface includes a configuration interface where the first configuration item is located and/or a configuration interface where a second configuration item is located, and the second configuration item is an upper-level configuration item of the first configuration item.

Another embodiment of the present disclosure provides an electronic device. The electronic device includes one or more processors; and a memory coupled to the one or more processors and storing program instructions that, when being executed, cause the one or more processors to perform: in response to a configuration operation acting on a first configuration item of an electronic device, updating an interface parameter of a target configuration interface of the electronic device to prompt a configuration item acted upon by the configuration operation. The target configuration interface includes a configuration interface where the first configuration item is located and/or a configuration interface where a second configuration item is located, and the second configuration item is an upper-level configuration item of the first configuration item.

Another embodiment of the present disclosure provides a non-transitory computer-readable storage medium, containing program instructions that, when being executed, cause at least one processor to perform: in response to a configuration operation acting on a first configuration item of an electronic device, updating an interface parameter of a target configuration interface of the electronic device to prompt a configuration item acted upon by the configuration operation. The target configuration interface includes a configuration interface where the first configuration item is located and/or a configuration interface where a second configuration item is located, and the second configuration item is an upper-level configuration item of the first configuration item.

### BRIEF DESCRIPTION OF THE DRAWINGS

FIG. 1 illustrates a flowchart of an information prompt method consistent with various embodiments of the present disclosure.

FIG. 2 illustrates a schematic diagram of a target configuration interface consistent with various embodiments of the present disclosure.

FIG. 3 illustrates a schematic diagram of another target configuration interface consistent with various embodiments of the present disclosure.

FIG. 4 illustrates a schematic diagram of adding configuration items to a first configuration interface consistent with various embodiments of the present disclosure.

FIG. 5 illustrates a schematic diagram of deleting configuration items from a first configuration interface consistent with various embodiments of the present disclosure.

FIG. 6 illustrates a schematic diagram of adding background data consistent with various embodiments of the present disclosure.

FIG. 7 illustrates a schematic diagram of adding display labels consistent with various embodiments of the present disclosure.

FIG. 8 illustrates another schematic diagram of adding display labels consistent with various embodiments of the present disclosure.

FIG. 9 illustrates a schematic diagram of a target display area consistent with various embodiments of the present disclosure.

FIG. 10 illustrates a schematic diagram of another target display area consistent with various embodiments of the present disclosure.

FIG. 11 illustrates a schematic structural diagram of an information prompt device consistent with various embodiments of the present disclosure.

### DETAILED DESCRIPTION OF THE EMBODIMENTS

Specific embodiments of the present disclosure are hereinafter described with reference to the accompanying drawings. The described embodiments are merely examples of the present disclosure, which may be implemented in various ways. Specific structural and functional details described herein are not intended to limit, but merely serve as a basis for the claims and a representative basis for teaching one skilled in the art to variously employ the present disclosure in substantially any suitable detailed structure. Various modifications may be made to the embodiments of the present disclosure. Those skilled in the art will envision other modifications within the scope and spirit of the present disclosure.

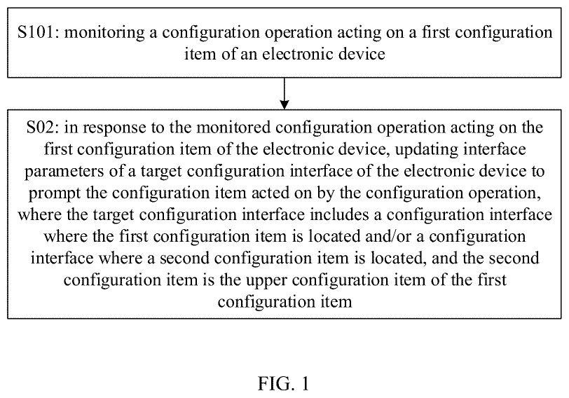

The present disclosure provides an information prompt method. As shown in FIG. 1, in one embodiment, the method may include:
S101, monitoring a configuration operation acting on first configuration items of an electronic device; and
S102, in response to the monitored configuration operation acting on the first configuration items of the electronic device, updating interface parameters of a target configuration interface of the electronic device to prompt the configuration items acted upon by the configuration operation, where the target configuration interface includes a configuration interface where the first configuration items are located and/or a configuration interface where second configuration items are located, and the second configuration items are upper-level configuration items of the first configuration items.

The execution subject of the information prompt method of this embodiment may be the electronic device acted on by the configuration operation.

A configuration item set to which the first configuration items belong may be any one of a configuration item set of a basic input and output system (BIOS) of the electronic device, a configuration item set of an operating system, a configuration item set of an application program, or a configuration item set of a user interface.

The configuration item set of the BIOS may include all configuration items belonging to the BIOS. The configuration item set of the operating system may include all configuration items belonging to the operating system. The configuration item set of any application program may include all configuration items belonging to the application program. The configuration item set of the user interface may include all configuration items belonging to the user interface.

In terms of the level, one first configuration item may be a configuration item of any level in the configuration item set to which it belongs.

Exemplarily, when the first configuration item is a configuration item of the BIOS, the first configuration item may specifically include at least one of first-level configuration items, second-level configuration items, third-level configuration items, or fourth-level configuration items of the BIOS.

The second configuration item may be the upper-level configuration item of the first configuration item, or the upper-level configuration item of the upper-level configuration item of the first configuration item, or a configuration item at a higher level than the first configuration item and including the first configuration item.

The target configuration interface may include at least one of an initial configuration interface where the first configuration item is located, an upper-level configuration interface of the configuration interface where the first configuration item is located, or a first configuration interface. The first configuration interface may be different from the initial configuration interface where the first configuration item is located and the upper-level configuration interface.

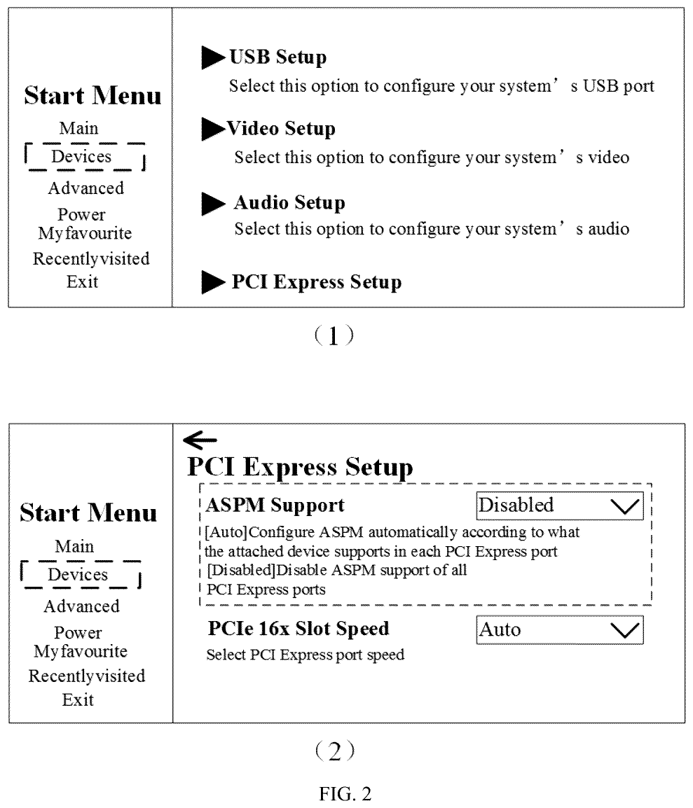

As an example, as shown in FIG. 2, the first configuration item may include the “ASPM Support” configuration item and the “PCIe 16x Slot Speed” configuration item in the BIOS.

The target configuration interface may include the configuration interface where the first configuration item shown in (2) of FIG. 2 is located, and the upper-level configuration interface of the configuration interface where the first configuration item is located shown in (1) of FIG. 2.

The second configuration item may be the upper-level configuration item “PCI Express Setup” of the first configuration item, the upper-level configuration item “Devices” of “PCI Express Setup”, the configuration item “Recently Visited”, or the configuration item “My Favorite”. Correspondingly, the first configuration interface may be the configuration interface corresponding to the configuration item “Recently Visited” or the configuration item “My Favorite”.

The configuration operation may be an operation of changing the configuration variable of the first configuration item.

In one embodiment shown in FIG. 2, the configuration operation obtained in S101 may be changing the value of the configuration variable “Gen4” of the configuration item “PCIe 16x Slot Speed” to “Auto”

The configuration operation may also be an operation to change the enable state of the first configuration item.

In one embodiment shown in FIG. 2, the configuration operation obtained in S101 may be an operation to change the enable state of the configuration item “ASPM Support” from “Enabled” to “Disabled”.

The configuration operation may also be an operation to change the access path of the first configuration item. For example, the configuration operation may be an operation to add the first configuration item from the initial configuration interface to the first configuration interface, or an operation to delete the first configuration item from the first configuration interface.

Changing the access path of the first configuration item may be achieved by changing the option corresponding to the first configuration item. For example, by selecting the option to add to the first configuration interface corresponding to the first configuration item, the first configuration item may be added to the first configuration interface. By selecting the option to delete from the first configuration interface corresponding to the first configuration item, the first configuration item may be deleted from the first configuration interface.

In S102, the electronic device may determine which first configuration items are affected by the configuration operation, for example, first determine which first configuration items are affected by the configuration operation, and then update the interface parameters according to the first configuration items affected by the configuration operation.

When the configuration operation is an operation of changing and saving the configuration variables of one first configuration item (including the configuration variable value of the configuration item, the enabled state of the configuration item, or the access path of the configuration item), the electronic device may determine the affected first configuration item through following processes. The electronic device may back up the configuration variables of each first configuration item before making corresponding changes and saving in response to the configuration operation, and may compare the configuration variables of each first configuration item after making corresponding changes and saving in response to the configuration operation with the configuration variables of one corresponding backed up first configuration items to determine the first configuration item in which the configuration variables are different as the first configuration item affected by the configuration operation.

Taking the first configuration item as a configuration item of BIOS as an example, the electronic device may back up the configuration variables of each configuration item in the current BIOS when it is turned on, assuming that the enable state of the configuration item “ASPM Support” is in the “Enabled” state at this time and the value of the configuration variable of the configuration item “PCIe 16x Slot Speed” is “Gen4”.

After the electronic device changes the configuration items of the BIOS in response to the configuration operation, the electronic device may compare the configuration variable values of each configuration item of the BIOS after the change with the configuration variable values backed up at startup, or compare the enabled state of each configuration item after the change with the enabled state backed up at startup, to find that the enabled state of the configuration item “ASPM Support” after the change is in the “Disabled” state which is different from the enabled state of the backup and find that the value of the configuration variable of the configuration item “PCIe 16x Slot Speed” is “Auto” which is different from the value of the backup configuration variable. Therefore, it may be determined that the configuration item “ASPM Support” and the configuration item “PCIe 16x Slot Speed” are the first configuration items affected by the configuration operation.

When the configuration operation is an operation to change the access path of the first configuration item, the electronic device may first determine the access path affected by the configuration operation, and then compare the first configuration item included in the access path before responding to the configuration operation and the first configuration item included in the access path after responding to the configuration operation, thereby determining the affected first configuration item. Exemplarily, when the access path changed by the configuration operation is the first configuration interface, the electronic device compares the first configuration item included in the first configuration interface before responding to the configuration operation and the first configuration item included in the first configuration interface after responding to the configuration operation, and finds that the first configuration interface after responding to the operation does not include the configuration item “Onboard Audio Controller” compared with the interface before responding to the operation, to determine that the configuration item is the first configuration item affected by the configuration operation. After determining the first configuration item affected by the configuration operation, the electronic device may determine the affected first configuration item and the second configuration item corresponding to the affected first configuration item as the configuration items affected by the configuration operation, and then update the interface parameters of the target configuration interface based on this. It may also determine only the affected first configuration item, or only the second configuration item corresponding to the affected first configuration item, as the configuration item affected by the configuration operation.

When the configuration operation is an operation to change the access path of one first configuration item, the electronic device may first determine the access path affected by the configuration operation, and then compare the first configuration item included in the access path before responding to the configuration operation and the first configuration item included in the access path after responding to the configuration operation, thereby determining the affected first configuration item.

Exemplarily, when the access path changed by the configuration operation is the first configuration interface, the electronic device may compare the first configuration items included in the first configuration interface before responding to the configuration operation and the first configuration items included in the first configuration interface after responding to the configuration operation, and find that the first configuration interface after responding to the operation does not have the configuration item “Onboard Audio Controller” compared to the interface before responding to the operation. Therefore, it may be determined that the configuration item “Onboard Audio Controller” is the first configuration item affected by the configuration operation.

After determining the first configuration item affected by the configuration operation, the electronic device may determine the affected first configuration item and the second configuration item corresponding to the affected first configuration item as the configuration items affected by the configuration operation, and then update the interface parameters of the target configuration interface based on this. Or, the electronic device may determine only the affected first configuration item, or only the second configuration item corresponding to the affected first configuration item, as the configuration item affected by the configuration operation.

In one embodiment, the first configuration interface may include configuration interfaces of several first configuration items determined according to the configuration operation. For example, the first configuration interface may include the first configuration items copied from the initial configuration interface by the electronic device in response to the configuration operation, or the first configuration interface may include several first configuration items affected by the configuration operation within a period of time.

In one embodiment shown in FIG. 2, for example, the first configuration interface may be a configuration interface displayed by the electronic device after selecting the configuration item “My Favorite” in FIG. 2, or may be a configuration interface displayed by the electronic device after selecting the configuration item “Recently visited” in FIG. 2.

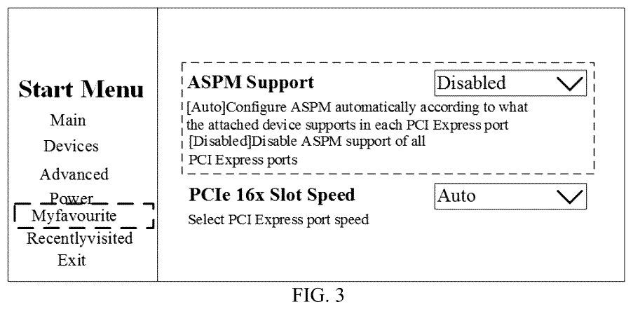

As an example, after selecting the configuration item “My Favorite” in FIG. 2, the electronic device may display the first configuration interface shown in FIG. 3.

The first configuration interface may be a configuration interface at the next level of the main configuration interface of the electronic device. The main configuration interface may refer to the first configuration interface displayed by default after the electronic device starts a program for changing configuration items.

The interface parameters of the target configuration interface may include at least one of the interface content parameters or the interface display parameters of the target configuration interface.

Updating the interface content parameters of the target configuration interface may include displaying text content that was not displayed before the update on the target configuration interface, for example, displaying configuration items that were not displayed before the update on the first configuration interface.

Updating the interface display parameters of the target configuration interface may include updating the color, mark, font, text size, or other parameters of the target configuration interface, for example, changing the color of a specific area in the target configuration interface from one color to another color, changing at least one of the color, font, or text size of a specific text in the target configuration interface.

Updating the interface display parameters of the target configuration interface may also include changing the statically displayed text in the target configuration interface to a dynamic display (e.g., flashing), or changing the dynamically displayed text to a static display.

Updating the interface display parameters of the target configuration interface may also include displaying graphic marks, text marks, or patterns that were not displayed before the update on the target configuration interface, or canceling the display of the content displayed before the update, for example, canceling the display of graphic marks, text marks or patterns that were displayed before the update.

In the present disclosure, after obtaining the configuration operation acting on the first configuration item, the interface parameters of the target configuration interface containing the first configuration item may be updated, and the configuration items acted on by the configuration operation may be prompted to the user through the updated target configuration interface. Therefore, the electronic device may indicate which configuration items are acted on by the configuration operation and which configuration items are not acted on by the configuration operation in the target configuration interface, thereby meeting the user's need to distinguish between the two types of configuration items in specific scenarios.

In some optional embodiments, the interface parameters of the target configuration interface may be updated in S102 by at least one of the following update strategies.

In the update strategy 1, in response to the configuration operation acting on the first configuration item of the electronic device, corresponding configuration information may be generated, and the interface content and/or display parameters of the target configuration interface may be updated based on the configuration information.

In the update strategy 2, based on the type of configuration operation and/or the attribute information of the first configuration item, the interface content and/or display parameters of the target configuration interface may be updated with the corresponding update methods, where different types of configuration operations correspond to different update methods.

In the update strategy 1, the generated configuration information may include at least one of the configuration variable results, configuration state results, or configuration variable change information, of the first configuration items acted on by the configuration operation. The configuration variable results may include the configuration variables of these first configuration items after the electronic device changes the acted first configuration items in response to the configuration operation. The configuration state results may include the enabled states of the changed first configuration items after the corresponding configuration items are changed in response to the configuration operation. The configuration variable change information may be the difference between the above configuration variable results and the initial values of the configuration variables of the acted first configuration items.

For example, the electronic device may change the configuration variable that determines the GPU power range from the first power range to the second power range in response to the configuration operation. The configuration variable results may be the changed second power range. The configuration variable change information may be the difference between the second power range and the first power range.

The generated configuration information may also include the setting content of the first configuration items affected by the configuration operation, and the setting content may include the enabling states of the first configuration items after the electronic device changes the first configuration items in response to the configuration operation, and may include copying the first configuration items to the first configuration interface or deleting the first configuration items from the first configuration interface.

The electronic device may generate the configuration information using at least one of the following generation methods.

In the generation method 1, target reference data may be obtained and may be used to compare the configuration variables of the first configuration items after the configuration operation (including the configuration variable values of the configuration items, the enabled states of the configuration items, or the access paths of the configuration items) to obtain the configuration information. The target reference data may represent the initial configuration variables of the configuration item set to which the first configuration items belong.

The initial configuration variables may be the configuration variables of each configuration item when the electronic device leaves the factory, or the configuration variables of each configuration item when it is turned on this time or before the configuration operation is obtained.

When the initial configuration variables are the configuration variables of each configuration item when the electronic device leaves the factory, the target reference data may be pre-written into a storage medium or a memory of the electronic device by the manufacturer when the electronic device leaves the factory, and may be directly read from the storage medium when it is needed.

When the initial configuration variables are the configuration variables of each configuration item when it is turned on this time or before the configuration operation is obtained, the target reference data may be obtained by backing up the configuration variables of each configuration item in the configuration item set to which the first configuration items belong after the configuration operation is detected and before the configuration items are changed in response to the configuration operation. It may also be obtained by backing up the configuration variables of each configuration item in the configuration item set to which the first configuration items belong when the electronic device is turned on, that is, when the power-on signal of the electronic device is detected.

For example, the electronic device may compare the configuration variables of the first configuration items after the configuration operation (including the configuration variable values of the configuration items, the enable states of the configuration items, and the access paths of the configuration items) with the target reference data, and find that the first configuration items affected by the configuration operation include the BIOS configuration item “ASPM Support” and the configuration item “PCIe 16x Slot Speed”, and that the enable state of the configuration item “ASPM Support” after the change is in the Enabled state, and the value of the configuration variable of the configuration item “PCIe 16x Slot Speed is Gen4”. Correspondingly, the electronic device may determine the enable state “Enabled” of the configuration item “ASPM Support” as one configuration state result, and determine the configuration variable “Gen4” of the configuration item “PCIe 16x Slot Speed” as one configuration variable result.

In the generation method 2, when the configuration operation changes the configuration variables of the first configuration items, the configuration information may be generated based on the configuration variables input by the configuration operation.

When the configuration operation includes inputting specific configuration variable values, the electronic device may identify the values of the configuration variables input by the configuration operation, and use the identified values as the configuration information. For example, the configuration operation may include setting the GPU power range to the second power range, and the electronic device may identify the values of the configuration variables included in the configuration operation, that is, identify the second power range, and determine the second power range as the configuration information.

When the configuration operation includes selecting a configuration variable option for a configuration item, the electronic device may identify the option selected by the configuration operation, and use the identified option as the configuration information. For example, the configuration information may include selecting the option to add to the first configuration interface corresponding to the configuration item “Onboard Audio Controller”.

When the electronic device updates the interface content and/or display parameters of the target configuration interface based on the configuration information, the update may be performed according to at least one of the following update strategies.

In the update strategy 3, when the configuration information indicates that the enable states of the first configuration items change, the display parameters of the first configuration items in their configuration interface and the display parameters of the corresponding configuration items of the first configuration items in the parent configuration interface of their configuration interface may be updated.

Exemplarily, when the configuration information indicates that the enable state of one first configuration item after the configuration operation is “Enable”, and the enable state of the first configuration item before the configuration operation is “Disabled”, or, when the configuration information indicates that the enable state of the first configuration item after the configuration operation is “Disabled”, and the enable state of the first configuration item before the configuration operation is “Enabled”, it may be determined that the enable state of the first configuration item has changed.

The configuration interface where the first configuration item is located may include the initial configuration interface where the first configuration item is located. Exemplarily, when the first configuration item is “PCIe 16x Slot Speed”, the initial configuration interface where the first configuration item is located may be the interface shown in (2) of FIG. 2.

When the first configuration interface displays the first configuration item, the configuration interface where the first configuration item is located may include the first configuration interface. Exemplarily, when the first configuration item is “PCIe 16x Slot Speed”, the first configuration interface displaying the first configuration item may be as shown in FIG. 3.

In the update strategy 4: when the configuration information indicates that the configuration operation configures the access path of the first configuration item, the display content of the first configuration interface may be updated.

When the configuration information includes a configuration variable selection option and the selected configuration variable option is related to the first configuration interface, it may be considered that the configuration information indicates that the configuration operation configures the access path of the first configuration item.

When the configuration variable option selected in the configuration information is an option to be added to the first configuration interface, the electronic device may display the first configuration item affected by the configuration operation in the first configuration interface, and synchronize the configuration variables and/or enable states of the first configuration item in the first configuration interface and the first configuration item in the initial configuration interface.

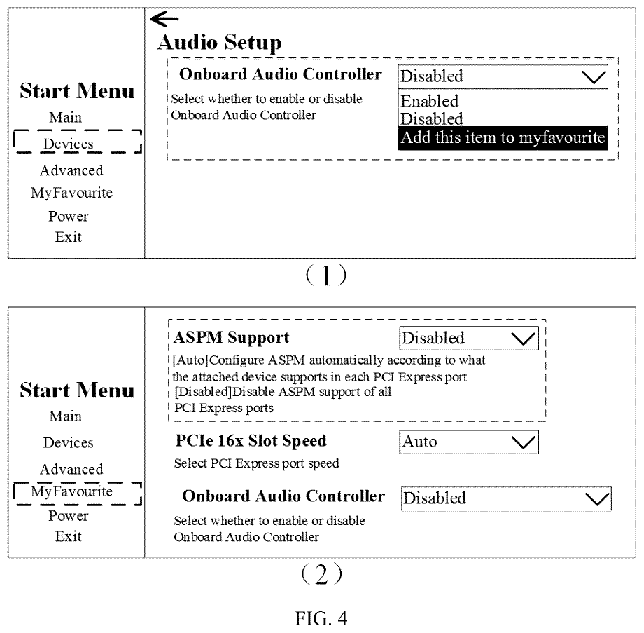

As an example, when the first configuration item is “Onboard Audio Controller” and the first configuration interface is the configuration interface corresponding to the configuration item “My Favorite”, the initial configuration interface where the first configuration item is located may be the interface shown in (1) of FIG. 4, and the configuration operation may include selecting an option to add to the first configuration interface in the initial configuration interface where the first configuration item is located, that is, selecting “Add this item to My Favorite”. After obtaining the configuration information representing the option, the electronic device may update the display content of the first configuration interface. The updated first configuration interface is shown in (2) of FIG. 4. After the update, the first configuration interface may display the first configuration item “Onboard Audio Controller” affected by the configuration operation, and the enabled state of the first configuration item in the first configuration interface may be consistent with the enabled state of the first configuration item in the initial configuration interface, both of which are Disabled.

When the configuration variable option selected in the configuration information is an option to be deleted from the first configuration interface, the electronic device may cancel the first configuration item affected by the display configuration operation in the first configuration interface.

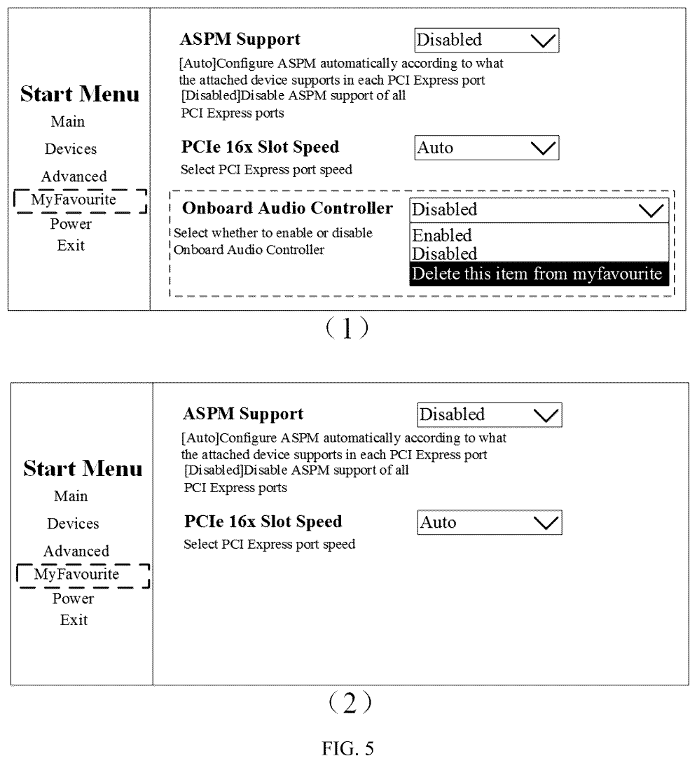

As another example, when the first configuration item is “Onboard Audio Controller” and the first configuration interface is the configuration interface corresponding to the configuration item “My Favorite”, the configuration operation may include selecting the option to delete from the first configuration interface corresponding to the first configuration item in the first configuration interface, such as selecting the option “Delete this item from My Favorite” in the interface shown in (1) of FIG. 5. After obtaining the configuration information representing the option, the electronic device may update the display content of the first configuration interface. The updated first configuration interface is shown in (2) of FIG. 5. In the updated first configuration interface, the electronic device may cancel the first configuration item “Onboard Audio Controller” affected by the display configuration operation.

In the update strategy 4, the display content of the first configuration interface may be updated by:
writing all configuration items synchronously into the first configuration interface, and hiding these configuration items by default, where all configuration items here may include all configuration items in the configuration item set to which the first configuration item belongs, for example, all configuration items in the BIOS;
when the option “Add to the first configuration interface” corresponding to any configuration item is selected, displaying the configuration item in the first configuration interface, and making the enabled state and/or configuration variable value of the configuration item in the first configuration interface synchronized with the enabled state and/or configuration variable value of the configuration item in the initial configuration interface; and

When the option “Delete from the first configuration interface” of any configuration item displayed in the first configuration interface is selected, hiding the configuration item in the first configuration interface.

In the update strategy 5, when the value of the configuration variable representing the first configuration item in the configuration information changes, the display parameters of the first configuration item in its configuration interface and the display parameters of the corresponding configuration item of the first configuration item in the upper-level configuration interface of its configuration interface may be updated.

As an example, the value of the configuration variable of the first configuration item may be the bandwidth of PCIe, the frequency range of the GPU or CPU of the electronic device, or the frequency of caches at all levels including L1, L2, L3 and L4 in the electronic device.

In the update strategy 6, when the configuration information indicates that the enabled state of the first configuration item has changed or the value of the configuration variable has changed, the first configuration item may be updated to the first configuration interface.

In the update strategy 6, the first configuration interface may be the configuration interface corresponding to the configuration item “Recently visited” shown in FIG. 2, which may be used to display the first configuration item that has been recently changed, including the first configuration item whose enabled state has changed or the first configuration item whose value of the configuration variable has changed.

According to the update strategy 6, when the configuration information indicates that the enabled state of the first configuration item has changed or the value of the configuration variable has changed, the electronic device may display the first configuration item in the first configuration interface.

Further, when the number of first configuration items displayed in the first configuration interface is larger than or equal to the set number threshold, the electronic device may cancel the display of the corresponding first configuration items from the first configuration interface one by one according to the display time from early to late, to ensure that the number of first configuration items displayed in the first configuration interface is less than the number threshold.

Alternatively, the electronic device may determine the time from the last time each first configuration item in the first configuration interface was changed to the current time. When the time is longer than the preset deletion time, the first configuration item may be canceled from the first configuration interface. Taking the deletion time of 10 days as an example, when the first configuration item “PCIe 16x Slot Speed” displayed in the first configuration interface has not changed in its enabled state and configuration variables in the last 10 days, the configuration item “PCIe 16x Slot Speed” may be canceled from the first configuration interface.

In the update strategy 2, the type of configuration operation may be any one of changing the configuration variable value of the first configuration item, changing the access path of the first configuration item, or changing the enabled state of the first configuration item.

The attribute information of the first configuration item may include the name of the first configuration item, the configuration item set to which the first configuration item belongs, or other information.

When the electronic device updates the interface content and/or display parameters of the target configuration interface in a corresponding update manner based on the type of configuration operation and/or the attribute information of the first configuration item, the update may be performed in at least one of the following update manners.

When the configuration operation is used to configure the enable state of the first configuration item or the value of the configuration variable, the display parameters of the first configuration item in its configuration interface and the display parameters of the corresponding configuration items of the first configuration item in the upper-level configuration interface of its configuration interface may be updated in the first update manner;

When the configuration operation is used to configure the enable state of the first configuration item or the value of the configuration variable, the first configuration item may be updated to the first configuration interface in the second update manner.

When the configuration operation is used to configure the access path of the first configuration item, the display content of the first configuration interface may be updated in the third update manner.

When the first configuration item belongs to the first configuration item set, the interface content and/or display parameters of the target configuration interface may be updated in the fourth update manner.

When the first configuration item belongs to the second configuration item set, the interface content and/or display parameters of the target configuration interface may be updated in the fifth update manner.

The first updating manner may include adding a display identifier and/or background data that was not there before the update on the configuration interface (including the initial configuration interface and the first configuration interface) where the first configuration item is located, where the position of the display identifier and/or background data may correspond to the position of the first configuration item. For example, the display identifier may be displayed on the same line as the name of the first configuration item and be located after the name of the first configuration item, and the background data may be displayed in a rectangular box containing the name of the first configuration item.

The first update manner may also include adding a display identifier and/or background data that was not displayed before the update in the upper-level configuration interface of the configuration interface where the first configuration item is located. The display position of the display identifier and/or background data may depend on the position of the second configuration item corresponding to the first configuration item in the upper-level configuration interface. For example, The display identifier may be displayed after the name of the second configuration item, and the background data may be displayed in a rectangular area including the name of the second configuration item.

The background data of the first update manner may be another background color different from the original background color of the configuration interface, or a preset background image, or background audio.

When the first update manner includes displaying the background data, the color of the text located on the background data may be updated synchronously with the display of the background data, such that the updated text may be distinguished from the background data.

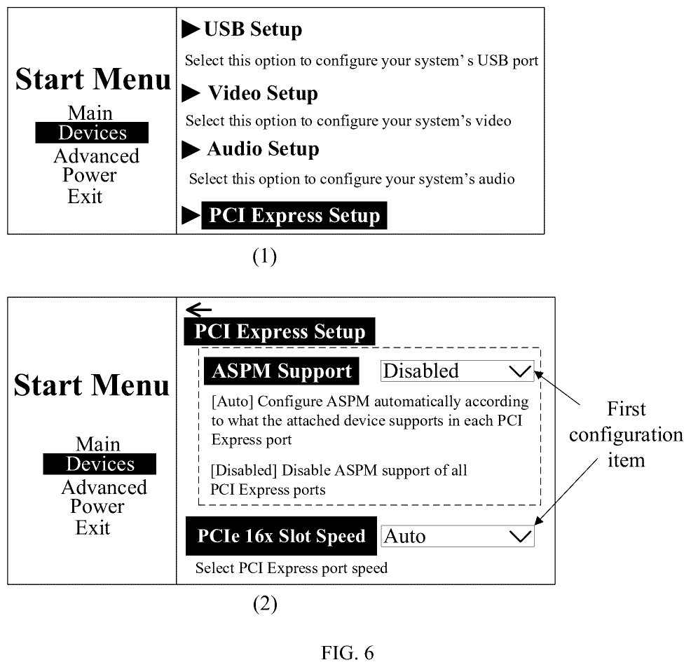

As an example, as shown in FIG. 6 which is a schematic diagram of a configuration interface after updating interface parameters, the first configuration items affected by the configuration operation may include the configuration item “ASPM Support” and the configuration item “PCIe 16x Slot Speed”. After the configuration operation, the configuration variables and/or enable states of the two first configuration items may be different from those before the configuration operation, and the corresponding second configuration item may include “PCI Express Setup and Devices”.

The electronic device, in the first update manner, may display a black background in the rectangular area where the name of the first configuration item and the name of the second configuration item are located in the initial configuration interface shown in (2) of FIG. 6, and change the names of these configuration items to white. Also, in the upper-level configuration interface shown in (1) of FIG. 6, a black background may be displayed in the rectangular area where the name of the second configuration item is located, and the names of these configuration items may be changed to white.

The display identifier may have various forms and positions. For example, the display identifier may be a specific graphic displayed after the name of the corresponding configuration item, an underline or a wavy line displayed below the name of the corresponding configuration item, or a rectangular frame surrounding the name of the corresponding configuration item.

The display identifier and/or background data may be displayed in the corresponding configuration interface in a floating display manner. At this time, the display identifier and/or background data and the original configuration interface may belong to different layers.

The display identifier and/or background data may also be displayed in the layer where the original configuration interface is located in a fusion display manner. At this time, the display identifier and/or background data and the original configuration interface may belong to the same layer.

Optionally, when adding the display identifier, the electronic device may add different display identifiers according to different first configuration items.

Exemplarily, for any configuration item affected by any configuration operation, when the enabled state and/or configuration variable value of the configuration item is different from the enabled state and/or configuration variable value at the time of leaving the factory, or the enabled state and/or configuration variable value of the subordinate configuration item of the configuration item is different from the enabled state and/or configuration variable value at the time of leaving the factory, the electronic device may add a corresponding first display identifier for the configuration item, for example, add the first display identifier after the name of the configuration item.

For any configuration item affected by any configuration operation, when the enabled state and/or configuration variable value of the configuration item is different from the configuration variable value and/or enabled state before this configuration operation, or the enabled state and/or configuration variable value of the subordinate configuration item of the configuration item is different from the configuration variable value and/or enabled state before this configuration operation, the electronic device may add a corresponding second display identifier for the configuration item, for example, add the second display identifier after the name of the configuration item.

The first display identifier and the second display identifier may be different. The first display identifier and the second display identifier may be displayed simultaneously.

As an example, the first display identifier may be an equilateral triangle identifier, and the second display identifier may be an inverted triangle identifier.

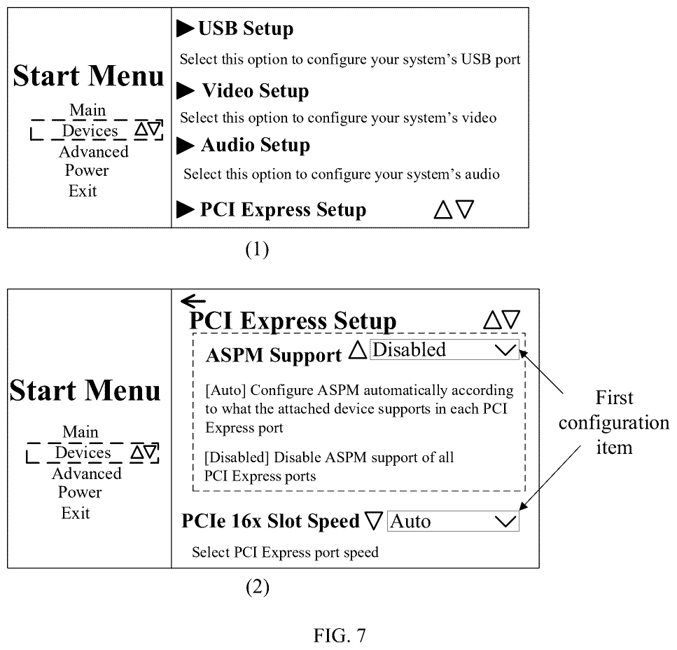

In one embodiment, for example, as shown in FIG. 7, after the electronic device changes the first configuration item in response to the configuration operation, the enabled state of the configuration item “ASPM Support” may be different from its enabled state when leaving the factory, and the value of the configuration variable of the configuration item “PCIe 16x Slot Speed” may be different from that before the current configuration operation. Therefore, the electronic device may display the first display mark, that is, the regular triangle mark, behind the name of the configuration item “ASPM Support” in the initial configuration interface where the first configuration item is shown in (2) of FIG. 7, and display the second display mark, that is, the inverted triangle mark, behind the name of the configuration item “PCIe 16x Slot Speed”.

In FIG. 7, the second configuration item corresponding to the first configuration item, that is, the configuration items “PCI Express Setup and Devices”, may meet the conditions for displaying the first display mark and the conditions for displaying the second display mark at the same time. Therefore, the electronic device may display the first display mark and the second display mark behind the name of the second configuration item in both the upper-level configuration interface shown in (1) of FIG. 7 and the initial configuration interface shown in (2).

In the second update manner, the electronic device may first copy or back up the first configuration item from the initial configuration interface where the first configuration item is located, and then add the copied or backed up first configuration item to the first configuration interface for display.

Exemplarily, after the electronic device changes the enabled state of the configuration item “ASPM Support” in response to the configuration operation, it may copy the configuration item “ASPM Support” and its enabled state, and then display the copied configuration item “ASPM Support” and its enabled state in the first configuration interface.

In this update manner, the first configuration interface may be the configuration interface corresponding to the aforementioned configuration item “Recently visited”.

In the third updating manner, the electronic device may copy the first configuration item and display the copied first configuration item in the first configuration interface, or may change the mapping address of the first configuration item such that the first configuration item is mapped to the first configuration interface and then display the first configuration item in the first configuration interface based on the mapping relationship.

Exemplarily, after the electronic device changes the enabled state of the configuration item “Onboard Audio Controller” in response to the configuration operation, the electronic device may copy the configuration item and the changed enabled state, and then display the copied configuration item and the enabled state in the first configuration interface.

In this updating method, the first configuration interface may be the configuration interface corresponding to the aforementioned configuration item “My Favorite”.

In the fourth updating method, the first configuration item set may be the BIOS configuration item set, and correspondingly, updating in the fourth updating method may include that, when the electronic device exits from the BIOS configuration interface in response to the operation of exiting the configuration interface, the interface parameters may be updated in accordance with the aforementioned update strategy and/or update method, or may include that, when the configuration operation is determined to be effective, the interface parameters are updated in accordance with the aforementioned update strategy and/or update method.

Determining that the configuration operation is effective may include that, when the electronic device obtains the user's operation of confirming the change, the configuration operation is determined to be effective. The operation of confirming the change may be an operation of the user clicking a save button displayed on the electronic device, or an operation of the user pressing a specific key on the keyboard for saving the change.

In the fifth update method, the second configuration item set may be at least one of a configuration item set of an operating system, a configuration item set of an application, or a configuration item set of a user interface. In this case, the electronic device may update the interface parameters according to the aforementioned update strategy and/or update method immediately after executing the configuration operation, or may update the interface parameters according to the aforementioned update strategy and/or update method after executing the configuration operation and refreshing the target configuration interface.

Optionally, updating the display parameters of the target configuration interface includes at least one of the following display modes.

In the display mode 1, corresponding display identifiers may be added in the first display area of the configuration interface of the first configuration item and the second display area of the upper-level configuration interface of the configuration interface, where the display identifiers of the first display area may be the same as or different from the display identifiers of the second display area.

In the display mode 2, the first configuration item and/or the second configuration item may be displayed and output in the configuration interface of the first configuration item and its upper-level configuration interface with character parameters that are different from other configuration items.

In the display mode 3, the first configuration item in the configuration interface of the first configuration item and its upper-level configuration interface may be displayed and output with a display output mode that is different from other configuration items.

In the display mode 4, corresponding background data may be added in the first display area of the configuration interface of the first configuration item and the second display area of the upper-level configuration interface of the configuration interface, where the background data of the first display area and the background data of the second display area are the same or different.

In the display mode 1, the position of the first display area may be determined according to the position of the name of the first configuration item in the configuration interface, and the position of the second display area may be determined according to the position of the name of the second configuration item in the upper-level configuration interface.

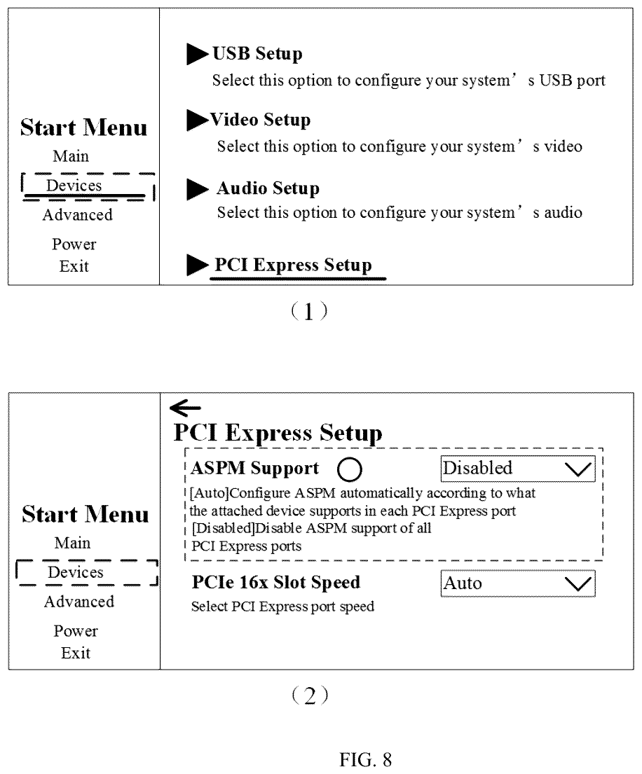

As an example, as shown in FIG. 8, which is a schematic diagram of an electronic device updating interface parameters according to the display mode 1, the first configuration item affected by the configuration operation is the configuration item “ASPM Support”, and the corresponding second configuration item includes the configuration item “PCI Express Setup and Devices”.

The interface shown in (2) of FIG. 8 is the initial configuration interface where the first configuration item “ASPM Support” is located. In this interface, the first display area may be the area behind the name of the first configuration item, and the electronic device may add a circular display mark in the first display area.

The interface shown in (1) of FIG. 8 may be the upper-level configuration interface of the initial configuration interface. In the upper-level configuration interface, the electronic device may determine the display area below the name of the second configuration item as the second display area, and display an underline mark in the area as the display mark of the second display area.

In the second display mode, the electronic device may change at least one of the font size, font and color of the first configuration item and/or the second configuration item in the interface where the first configuration item is located and its upper-level configuration interface, such that the first configuration item and/or the second configuration item are distinguished from other configuration items in the configuration interface that are not affected by the configuration operation.

For example, the text font size of the first configuration item and/or the second configuration item may be size 4, and the text font size of other configuration items that are not affected by the configuration operation may be size 5, size 3 or other font sizes different from size 4.

The text font of the first configuration item and/or the second configuration item may be italic, and the text font of other configuration items that are not affected by the configuration operation may be non-italic. Or, the text font of the first configuration item and/or the second configuration item may be bold, and the text font of other configuration items that are not affected by the configuration operation may be non-bold.

The text color of the first configuration item and/or the second configuration item may be red, and the text color of other configuration items that are not affected by the configuration operation may be black.

In the display mode 3, the electronic device may display and output the text of the first configuration item and/or the second configuration item in a dynamic display mode, and the text of other configuration items that are not affected by the configuration operation may be displayed and output in a static display mode. There may be many ways of dynamic display, including but not limited to text flashing, text flying in from one side of the screen and flying out from the other side, or text scrolling display in a certain range vertically or horizontally.

In the display mode 4, the first display area may be a rectangular area where the name of the first configuration item is located in the configuration interface where the first configuration item is located; and the second display area may be a rectangular area where the name of the second configuration item is located in the upper-level configuration interface.

Optionally, the second configuration item may also be displayed in the configuration interface where the first configuration item is located, and the first display area may also include a rectangular area where the name of the second configuration item is located in the configuration interface where the first configuration item is located.

The background data may be a background pattern, a background color, or a background audio.

When the background data is a background pattern or a background color, the electronic device may directly display the first background pattern in the first display area and the second background pattern in the second display area; or may directly display the first background color in the first display area and the second background color in the second display area.

The first background pattern and the second background pattern may be the same or different. The first background color and the second background color may be the same or different.

When the background data is background audio, the electronic device may associate the first display area with the first background audio, and associate the second display area with the second background audio. When the cursor of the electronic device moves to the first display area, the electronic device may play the first background audio, and when the cursor of the electronic device moves to the second display area, the electronic device may play the second background audio.

The first background audio and the second background audio may be the same or different.

Optionally, in one embodiment, the prompt method of this embodiment may also perform the following steps when prompting the configuration item affected by the configuration operation:
in response to the operation of switching the current configuration interface of the first configuration item, outputting the prompt information of the configuration item that at least reflects the change of the configuration variable in the upper-level configuration interface and/or the first configuration interface of the configuration interface of the first configuration item in a corresponding output mode based on the switching mode.

The operation of switching the current configuration interface (referred to as the switching operation) may include at least one of: minimizing the current configuration interface, closing the current configuration interface, returning to the upper-level configuration interface, returning to the main configuration interface, the operation of entering the next-level configuration interface, moving the current configuration interface to the specified display area, or dragging.

The dragging operation may be an operation for dragging the first configuration item from the current initial configuration interface to add it to the first configuration interface.

Optionally, displaying the prompt information in response to the switching operation may include at least one of the following prompting modes.

In the prompt mode 1, when the switching mode is closing the current configuration interface, the current configuration interface may be minimized, or the current configuration interface may be moved to a designated display area, and the corresponding prompt information may be output by outputting the configuration variable change content and/or time.

In the prompt mode 2, when the switching mode is returning to the upper-level configuration interface, the corresponding prompt information may be output by adjusting the configuration item display parameter.

In the prompt mode 1, the change content of the configuration variable may include the value of the configuration variable of the first configuration item and/or the enabled state of the first configuration item before responding to the configuration operation, and the value of the configuration variable of the first configuration item and/or the enabled state of the first configuration item after the first configuration item is changed in response to the configuration operation.

The configuration variable change time may be the time when the electronic device obtains the configuration operation, or the time when the configuration variable takes effect.

The electronic device may output the prompt information in a variety of ways, including but not limited to pop-up window displaying or on-screen displaying (OSD) of the prompt information, voice broadcast of the prompt information, or sending prompt information to associated devices.

The associated devices may be any devices that are connected to the electronic device for communication, such as a display screen connected to the electronic device via Bluetooth, another electronic device connected to the electronic device via a network, a mobile terminal connected to the electronic device via a data cable, etc.

In the second prompt mode, the adjustment of the display parameters of the configuration item may include any of the aforementioned methods of adding display marks, background data, adjusting fonts, or dynamic output, which will not be repeated.

Optionally, in one embodiment, the prompt method may also include:
in response to a configuration operation acting on a second configuration item added to the first configuration interface, synchronously updating the configuration variable data changed by the corresponding configuration operation in the configuration interface to which the second configuration item belongs, where the second configuration item may be dragged from the configuration interface to which it belongs to the first configuration interface.

Exemplarily, after the configuration item “ASPM Support” is added to the first configuration interface, when the electronic device obtains a configuration operation to change the enabled state of the configuration item “ASPM Support”, the electronic device may synchronously update the initial configuration interface shown in (2) of FIG. 2 according to the configuration operation, and update the enabled state of the configuration item “ASPM Support” in the first configuration interface shown in FIG. 3.

After the configuration item “PCIe 16x Slot Speed” is added to the first configuration interface, when the electronic device obtains a configuration operation to change the configuration variable of the configuration item “PCIe 16x Slot Speed”, the electronic device may synchronize the initial configuration interface shown in (2) of FIG. 2 and update the configuration variable of the configuration item “PCIe 16x Slot Speed” in the first configuration interface shown in FIG. 3 according to the configuration operation, for example, synchronously update from “Auto” to “Gen4”.

In one embodiment, the prompt method may also include:
updating timestamp information of the configuration operation and/or the historical configuration data of the first configuration item to the target display area of the target configuration interface.

In addition to the timestamp information and the historical configuration data, the target display area may also display the number of configurations of the first configuration item.

The historical configuration data may include the enable state and/or the configuration variable value after each change of the first configuration item.

The target display area may be a display area directly determined by the electronic device in the target configuration interface according to the location of the configuration item.

The target display area may also be a new configuration interface displayed by the electronic device in response to the user's operation of opening the target display area. This new configuration interface may be a lower-level configuration interface of the configuration interface where the first configuration item is located, or may be a higher-level configuration interface of the configuration interface where the first configuration item is located.

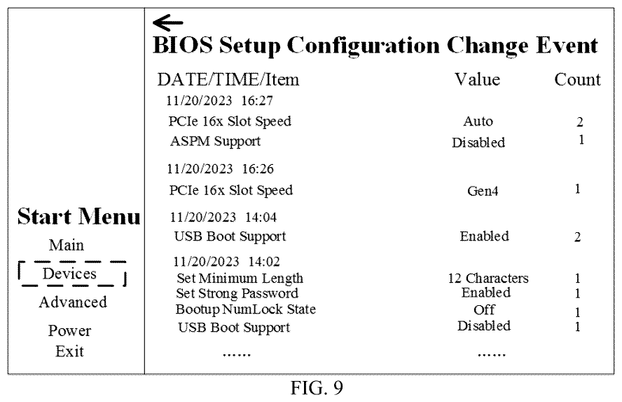

As an example, the target display area displayed by the electronic device may be the configuration interface shown in FIG. 9. In FIG. 9, “DATE/TIME/Item” indicates the timestamp of obtaining the configuration operation, the configuration item below the timestamp is the configuration item affected by the configuration operation, “Value” indicates the configuration variable or enabled state of the configuration item affected by the configuration operation, and “Count” indicates the number of configurations.

In the above-mentioned target display area, the configuration number corresponding to each configuration item may indicate the number of times the configuration item appears in the target display area. For example, when the configuration item “PCIe 16x Slot Speed” appears for the first time, the corresponding configuration number may be 1, and the timestamp may be 11/20/2023, 16:26, indicating that, in the information displayed in the target display area, the configuration item “PCIe 16x Slot Speed” is first changed at 11/20/2023, 16:26.When the configuration item “PCIe 16x Slot Speed” appears for the second time, the corresponding configuration number may be 2, and the timestamp may be 11/20/2023, 16:27, indicating that, in the information displayed in the target display area, the configuration item “PCIe 16x Slot Speed” is changed for the second time at Nov. 20, 2023, 16:27.

The target display area may be a rectangular area below the name of the first configuration item in the configuration interface where the first configuration item is located, and the rectangular area may display the timestamp information of each change of the first configuration item and the historical configuration data of the first configuration item.

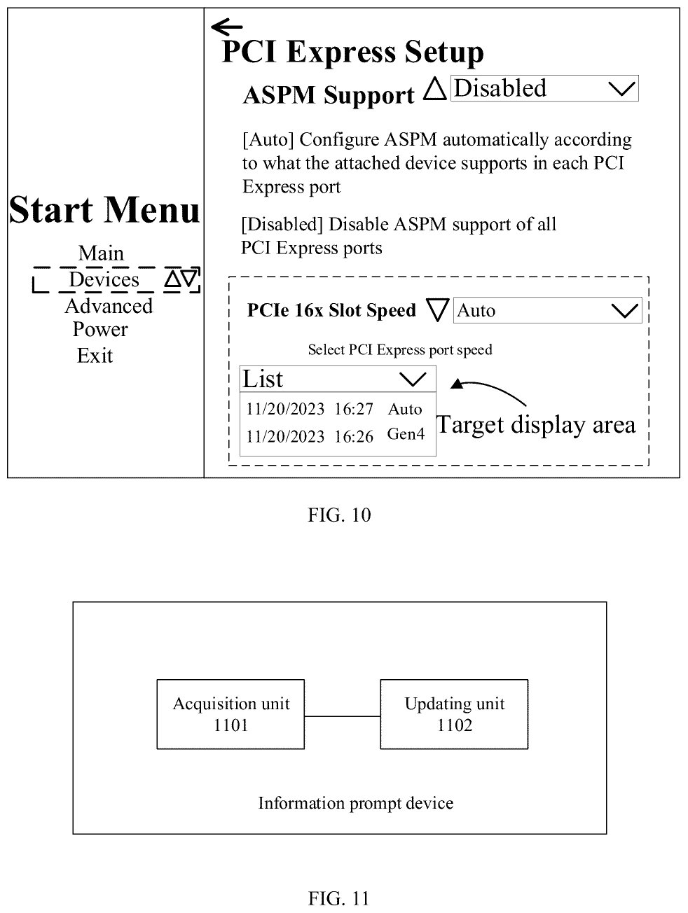

As an example, in one embodiment shown in FIG. 10, a target display area may be displayed below the first configuration item “PCIe 16x Slot Speed”, in which the timestamp of the change of the first configuration item and the configuration variables of the changed first configuration item are displayed.

When the target display area is displayed, the electronic device may perform at least one of the following operations.

First, according to the user's selection instruction, the timestamp information, historical configuration data and configuration times of the selected configuration item may be highlighted.

For example, after the user selects the configuration item “PCIe 16x Slot Speed”, the electronic device may highlight the timestamp information, historical configuration data and configuration times of the configuration item in the target display area. The highlighting method may include changing the display font, dynamic display method, or background of this information, etc., without limitation.

Second, the timestamp information, historical configuration data and configuration times of the relevant configuration items may be highlighted.

The relevant configuration items here may include configuration items related to the target attribute specified by the user, and the target attribute may be any device attribute of the electronic device, including but not limited to at least one of display resolution, boot time, network rate, or power consumption.

Exemplarily, after the user specifies the network rate as the target attribute, the electronic device may search for the configuration items related to the network rate in the configuration items contained in the target display area, and then highlight the timestamp information, historical configuration data and configuration times of these configuration items.

Third, the timestamp information, historical configuration data and configuration times of the target configuration item may be highlighted.

The target configuration item may be the configuration item containing the target character input by the user.

For example, as shown in FIG. 9, assuming that the target character input by the user is “Support”, the electronic device may determine the configuration item “ASPM Support” and the configuration item “USB Boot Support” in the target display area as the target configuration item.

Fourth, information that the time length of the timestamp from the current timestamp of the electronic device is less than or equal to the time length threshold may be displayed.

The time length threshold may be set to 24 hours or other values.

Taking the duration threshold of 24 hours as an example, assuming that the current timestamp of the electronic device is 11/20/2023, 14:00, the electronic device may only display the configuration items and corresponding historical configuration data affected by the configuration operation within 24 hours from 11/20/2023, 14:00 to 11/20/2023, 14:00 shown in FIG. 9.

Fifth, a target time period may be determined, and information of the configuration items configured in the target time period according to the timestamp may be displayed.

The target time period may be specified by the user.

Exemplarily, the user may specify the target time period as 11/20/2023, 0:00 to 11/20/2023, 0:00. Based on the target time period, the electronic device may display the configuration items affected by the configuration operations obtained in the time period, as well as the historical configuration data and configuration times of these configuration items in the target display area.

Sixth, a statistical period may be determined, and the number of adjustments corresponding to the statistical period according to the timestamp may be displayed.

The number of adjustments corresponding to the statistical period may be the number of times the configuration items change according to the configuration operation in the statistical operation.

There can be one or more statistical periods, and they can be specified by the user.

For example, as shown in FIG. 9, the user may specify the statistical period as 11/21/2023, 14:00 to 11/21/2023, 15:00. The electronic device may count the information displayed in the target display area according to the statistical period and find that three configuration items are changed in the statistical period, among which the configuration item “USB Boot Support” is changed twice. Based on this, the electronic device may determine that the number of adjustments corresponding to the statistical period is 5.

Seventh, when displaying the target configuration interface, the number of configuration corresponding to the first configuration item may be displayed.

For example, as shown in FIG. 9, when the electronic device displays the target configuration interface shown in (2) of FIG. 2, the latest configuration number 2 of the configuration item may be displayed at the corresponding position of the configuration item “PCIe 16x Slot Speed”, for example, after the name of the configuration item, to indicate that the configuration item has been configured twice.

Optionally, when the electronic device displays the target configuration interface, it may first determine whether the configuration number of the configuration item meets the configuration number condition. When the configuration number of the configuration item meets the configuration number condition, the corresponding configuration number may be displayed in the above manner. When the configuration number of the configuration item does not meet the configuration number condition, the corresponding configuration number may not be displayed in the above manner.

The configuration number condition may be that the latest configuration number is larger than or equal to the configuration times threshold. The configuration times threshold may be set as needed and is not limited.

For example, the configuration times threshold may be set to 2. When the electronic device displays the target configuration interface shown in (2) of FIG. 2, the latest configuration times of the configuration item “PCIe 16x Slot Speed” may be 2, which satisfies the configuration times condition. The latest configuration times of the configuration item “ASPM Support” may be 1, which does not satisfy the configuration times condition. Therefore, the electronic device may only display the configuration times after the name of the configuration item “PCIe 16x Slot Speed”, but not the configuration times of the configuration item “ASPM Support”.

In some optional embodiments, after updating the interface parameters of the target configuration interface to prompt the configuration items affected by the configuration operation, the electronic device may restore the updated interface parameters to the state before the update if the configuration items affected by the configuration operation meet the cancellation conditions, thereby canceling the prompt for the corresponding configuration items. When the configuration items affected by the configuration operation after the update do not meet the cancellation conditions, the electronic device may display the target configuration interface according to the updated interface parameters each time it displays the target configuration interface.

The cancellation condition may include at least one of the following conditions.

A cancellation condition 1 may include obtaining the user's update cancellation operation. The update cancellation operation may be any operation acting on the updated interface parameters.

Taking FIG. 7 as an example, the update cancellation operation may be a double-click operation on the equilateral triangle mark and the inverted triangle mark shown in FIG. 7. After obtaining the update cancellation operation, the electronic device may restore the equilateral triangle mark and the inverted triangle mark shown in FIG. 7 to the state before the update, that is, cancel the display of the equilateral triangle mark and the inverted triangle mark shown in FIG. 7.

A cancellation condition 2 may include that the configuration variable of the first configuration item acted by the configuration operation is consistent with the corresponding initial configuration variable, or the enabled state of the first configuration item acted by the configuration operation is consistent with the initial enabled state.

Taking FIG. 7 as an example, assuming that the initial enabled state of the configuration item “ASPM Support” is “Enabled”, after the electronic device responds to a certain configuration operation, it may change the enabled state of the configuration item “ASPM Support” from “Disabled” as shown in (2) of FIG. 7 to “Enabled”. At this time, the enabled state of the configuration item “ASPM Support” is consistent with the initial enabled state. Therefore, the electronic device may cancel the display of the equilateral triangle mark of the configuration item “ASPM Support” and the corresponding second configuration item “PCIe Express Setup and Devices”.

A cancellation condition 3 may include that the electronic device responds to the configuration operation again and changes the configuration item, and the configuration item affected by the configuration operation responded again is different from the configuration item affected by the configuration operation responded previously. In this case, the prompt of the configuration item that is not affected by the configuration operation responded again may be canceled.

Taking FIG. 7 as an example, assuming that the electronic device changes the configuration variable of the configuration item “PCIe 16x Slot Speed” from “Gen4” to “Auto” in response to the first configuration operation, the electronic device may update the interface parameters of the target configuration interface shown in FIG. 7 and display an inverted triangle mark after the configuration item “PCIe 16x Slot Speed” and its corresponding second configuration item “PCIe Express Setup and Devices”.

After a period of time, the electronic device may change the enable state of the configuration item “Onboard Audio Controller” from “Disabled” to “Enabled” in response to the second configuration operation. The configuration items affected by the second configuration operation may include “Onboard Audio Controller” and its corresponding second configuration item “Audio Setup and Devices”, but may not include the configuration items “PCIe 16x Slot Speed” and “PCIe Express Setup” affected by the first configuration operation. Therefore, the electronic device may cancel the prompt for the configuration items “PCIe 16x Slot Speed” and “PCIe Express Setup” by restoring the updated interface parameters, that is, the electronic device may cancel the inverted triangle marks displayed after the configuration items “PCIe 16x Slot Speed” and “PCIe Express Setup” in FIG. 7.

A cancellation condition 4 may include that the configuration variable and/or the enabled state of the first configuration item acted upon by the configuration operation is not changed within a target duration after responding to the configuration operation.

The target duration may be set as needed. Exemplarily, the target duration may be set to 7 days. Taking FIG. 7 as an example, after the electronic device changes the configuration variable of the configuration item “PCIe 16x Slot Speed” from “Gen4” to “Auto” in response to the configuration operation, the electronic device may update the interface parameters of the target configuration interface, that is, an inverted triangle mark may be displayed after the configuration item “PCIe 16x Slot Speed” and its corresponding second configuration item. Within 7 days thereafter, each time the electronic device displays the target configuration interface shown in FIG. 7, an inverted triangle mark may be displayed at the corresponding position in the manner shown in FIG. 7. After 7 days, when the configuration variable of the configuration item “PCIe 16x Slot Speed” is still not “Auto”, the electronic device may cancel the inverted triangle mark at the corresponding position in the target configuration interface. That is, the target configuration interface shown in FIG. 7 displayed by the electronic device after 7 days may not include the inverted triangle mark shown in the figure.

A cancellation condition 5 may include that, when the configuration item affected by the configuration operation belongs to the BIOS configuration item set, if the electronic device is shut down and restarted twice after updating the interface parameters, and the electronic device does not change the configuration item affected by the configuration operation during the period from the first shutdown and restart to the second shutdown and restart, after the second shutdown and restart, the electronic device may restore the updated interface parameters to cancel the prompt for the configuration item affected by the configuration operation.

Taking FIG. 7 as an example, assuming that the electronic device changes the configuration variable of the configuration item “PCIe 16x Slot Speed” from “Gen4” to “Auto” in response to the first configuration operation, the electronic device may update the interface parameters of the target configuration interface shown in FIG. 7, and display an inverted triangle mark after the configuration item “PCIe 16x Slot Speed” and its corresponding second configuration item “PCIe Express Setup and Devices”.

After a period of time, the electronic device may be shut down and restarted. After the restart, the configuration item “PCIe 16x Slot Speed” may not be changed during the operation of the electronic device. After running for a period of time, the electronic device may be shut down and restarted again. After the shutdown and restart again, the electronic device may cancel the inverted triangle mark after the configuration items “PCIe 16x Slot Speed” and “PCIe Express Setup and Devices” on the target configuration interface.

The present disclosure also provides an information prompt device. In one embodiment shown in FIG. 11 which is a structural schematic diagram of an information prompting device, the information prompting device may include:
an acquisition unit 1101, used to monitor a configuration operation acting on a first configuration item of an electronic device; and
an updating unit 1102, used to update interface parameters of a target configuration interface of the electronic device in response to the monitored configuration operation acting on the first configuration item of the electronic device, to prompt the configuration item acted by the configuration operation. The target configuration interface may include a configuration interface where the first configuration item is located and/or the configuration interface where a second configuration item is located, and the second configuration item may be an upper-level configuration item of the first configuration item.

Optionally, when the updating unit 1102 updates the interface parameters of the target configuration interface of the electronic device in response to the configuration operation acting on the first configuration item of the electronic device, it may be used to:
generate corresponding configuration information in response to the configuration operation acting on the first configuration item of the electronic device, and update interface content and/or display parameters of the target configuration interface based on the configuration information; and
update the interface content and/or display parameters of the target configuration interface in a corresponding update manner based on the type of configuration operation and/or the attribute information of the first configuration item, where different types of configuration operations correspond to different update manners.

The target configuration interface may include at least one of the configuration interface of the first configuration item, the upper-level configuration interface of the configuration interface of the first configuration item, and the first configuration interface. The first configuration interface may be different from the configuration interface of the first configuration item and its upper-level configuration interface.

Optionally, when the updating unit 1102 generates the corresponding configuration information, the updating unit 1102 may perform at least one of:
obtaining target reference data and using the target reference data to compare the configuration variables of the first configuration item after the configuration operation to obtain configuration information, wherein the target reference data represents the initial configuration variables of the configuration item set to which the first configuration item belongs; and
when the configuration operation changes the configuration variables of the first configuration item, generating the configuration information based on the configuration variables input by the configuration operation.

Optionally, when the update unit 1102 updates the interface content and/or display parameters of the target configuration interface based on the configuration information, the updating unit 1102 may perform at least one of:
when the configuration information indicates that the enabled state of the first configuration item has changed, updating the display parameters of the first configuration item in its configuration interface and the display parameters of the corresponding configuration items of the first configuration item in the upper-level configuration interface of its configuration interface;
when the configuration information indicates that the configuration operation configures the access path of the first configuration item, updating the display content of the first configuration interface;
when the configuration information indicates that the values of the configuration variables of the first configuration item have changed, updating the display parameters of the first configuration item in its configuration interface and the display parameters of the corresponding configuration items of the first configuration item in the upper-level configuration interface of its configuration interface; or
when the configuration information indicates that the enabled state of the first configuration item has changed or the value of the configuration variable has changed, updating the first configuration item to the first configuration interface.

Optionally, when the updating unit 1102 updates the interface content and/or display parameters of the target configuration interface in the corresponding updating manner based on the type of configuration operation and/or the attribute information of the first configuration item, the updating unit 1102 may perform at least one of:
when the configuration operation is used to configure the enabled state of the first configuration item or the value of the configuration variable, updating the display parameters of the first configuration item in its configuration interface and the display parameters of the corresponding configuration items of the first configuration item in the upper-level configuration interface of its configuration interface in a first updating manner;
when the configuration operation is used to configure the enabled state of the first configuration item or the value of the configuration variable, updating the first configuration item to the first configuration interface in a second updating manner;
when the configuration operation is used to configure the access path of the first configuration item, updating the display content of the first configuration interface in a third updating manner;
when the first configuration item belongs to the first configuration item set, updating the interface content and/or display parameters of the target configuration interface in a fourth updating manner; or
when the first configuration item belongs to the second configuration item set, updating the interface content and/or display parameters of the target configuration interface in a fifth updating manner.

Optionally, when the update unit 1102 updates the display parameters of the target configuration interface, the updating unit 1102 may perform at least one of:
adding a corresponding display identifier in the first display area of the configuration interface of the first configuration item and the second display area of the upper-level configuration interface of the configuration interface respectively, where the display identifier of the first display area is the same as or different from the display identifier of the second display area;
displaying and outputting the first configuration item and/or the second configuration item in the configuration interface of the first configuration item and its upper-level configuration interface with character parameters that are different from other configuration items;
displaying and outputting the first configuration item in the configuration interface of the first configuration item and its upper-level configuration interface with a display output method that is different from other configuration items;
adding corresponding background data in the first display area of the configuration interface of the first configuration item and the second display area of the upper-level configuration interface of the configuration interface, wherein the background data of the first display area and the background data of the second display area are the same as or different from the background data of the second display area.

Optionally, when the updating unit 1102 prompts the configuration item affected by the configuration operation, the updating unit 1102 may be used to:
in response to the operation of switching the current configuration interface of the first configuration item, output the prompt information of the configuration item that at least reflects the change of the configuration variable in the upper-level configuration interface of the configuration interface of the first configuration item and/or the first configuration interface in a corresponding output mode based on the switching mode.

Optionally, when the updating unit 1102 outputs the prompt information of the configuration item that at least reflects the change of the configuration variable in the upper-level configuration interface of the configuration interface of the first configuration item and/or the first configuration interface in a corresponding output mode based on the switching mode, the updating unit 1102 may perform at least one of the following:
when the switching mode is to close the current configuration interface, minimizing the current configuration interface, or moving the current configuration interface to the specified display area, outputting the corresponding prompt information in the form of outputting the content and/or time of the configuration variable change; or
when the switching mode is to return to the upper-level configuration interface, outputting the corresponding prompt information in the form of adjusting the display parameters of the configuration item.

Optionally, the updating unit 1102 may further perform at least one of the following:
in response to a configuration operation acting on a second configuration item added to the first configuration interface, synchronously updating the configuration variable data changed by the corresponding configuration operation in the configuration interface to which the second configuration item belongs, where the second configuration item may be dragged from the configuration interface to which it belongs to the first configuration interface; or

Updating the timestamp information of the configuration operation and/or the historical configuration data of the first configuration item to the target display area of the target configuration interface.

The specific implementation and benefits of the information prompt device provided by the present disclosure may refer to the relevant steps and beneficial effects of the information prompt method provided in any embodiments of the present disclosure, and will not be repeated here.

Each embodiment in this specification is described in a progressive manner, and each embodiment focuses on the differences from other embodiments. The same or similar parts between the embodiments may be referred to each other.

For the convenience of description, the above system or device is described in various modules or units according to their functions. Of course, when implementing, the functions of each unit may be implemented in the same or one or more software and/or hardware.

The embodiments of the present disclosure may be implemented by means of software plus a necessary general hardware platform. Based on this understanding, the technical solution of the present disclosure may be essentially or partly embodied in the form of a software product that contributes to the prior art. The computer software product may be stored in a storage medium, such as a ROM/RAM, a magnetic disk, an optical disk, etc., and may include several instructions for enabling a computer device (which can be a personal computer, a server, or a network device, etc.) to implement all or some parts of the method provided by various embodiments of the present disclosure.

In the present disclosure, relational terms such as first, second, third, and fourth, etc., are used merely to distinguish one entity or operation from another entity or operation but do not necessarily require or imply any such actual relationship or order between these entities or operations. Also, the terms “comprises,” “includes,” or any other variation thereof are intended to cover a non-exclusive inclusion, such that an article or device including a list of elements includes not only those elements, but also other elements not expressly listed. Or it also includes elements inherent to the article or equipment. Without further limitation, an element associated with the statement “comprises a . . . ” does not exclude the presence of other identical elements in an article or device that includes the above-mentioned element.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the present disclosure. Thus, while the present disclosure has been described in detail with reference to the above described embodiments, the present disclosure is not limited to the above described embodiments, but may be embodied in other equivalent forms without departing from the scope of the present disclosure.

What is claimed is:

1. An information prompt method, comprising:
in response to a configuration operation acting on a first configuration item of an electronic device,
updating an interface parameter of a target configuration interface of the electronic device to prompt a configuration item acted upon by the configuration operation,
wherein the target configuration interface includes a configuration interface where the first configuration item is located and/or a configuration interface where a second configuration item is located, and the second configuration item is an upper-level configuration item of the first configuration item.

2. The method according to claim 1, wherein in response to the configuration operation acting on the first configuration item of the electronic device, updating the interface parameter of the target configuration interface of the electronic device includes at least one of:
in response to the configuration operation acting on the first configuration item of the electronic device, generating corresponding configuration information, and updating an interface content and/or a display parameter of the target configuration interface based on the configuration information; or
updating the interface content and/or the display parameter of the target configuration interface in a corresponding update manner based on a type of the configuration operation and/or attribute information of the first configuration item, wherein different types of configuration operations correspond to different update manners,
wherein:
the target configuration interface includes at least one of the configuration interface of the first configuration item, the upper-level configuration interface of the configuration interface of the first configuration item, or a first configuration interface; and
the first configuration interface is different from the configuration interface of the first configuration item and the upper-level configuration interface of the configuration interface of the first configuration item.

3. The method according to claim 2, wherein generating the corresponding configuration information includes at least one of:
obtaining target reference data and using the target reference data to compare configuration variables of the first configuration item after the configuration operation, to obtain the configuration information, wherein the target reference data represents initial configuration variables of a configuration item set to which the first configuration item belongs; or
when the configuration operation changes the configuration variables of the first configuration item, generating the configuration information based on the configuration variables input by the configuration operation.

4. The method according to claim 2, wherein updating the interface content and/or the display parameter of the target configuration interface based on the configuration information includes at least one of:
when the configuration information indicates that an enable state of the first configuration item is changed, updating the display parameter of the first configuration item in the configuration interface of the first configuration item and display parameters of corresponding configuration items of the first configuration item in the upper-level configuration interface of the configuration interface of the first configuration item;
when the configuration information indicates that the configuration operation configures an access path of the first configuration item, updating the display content of the first configuration interface;
when the configuration information indicates that values of the configuration variables of the first configuration item are changed, updating the display parameter of the first configuration item in the configuration interface of the first configuration item and display parameters of the corresponding configuration items of the first configuration item in the upper-level configuration interface of the configuration interface of the first configuration item; or
when the configuration information indicates that the enable state of the first configuration item is changed or the values of the configuration variables are changed, updating the first configuration item to the first configuration interface.

5. The method according to claim 2, wherein updating the interface content and/or the display parameter of the target configuration interface in the corresponding update manner based on the type of the configuration operation and/or the attribute information of the first configuration item, includes at least one of:
when the configuration operation is used to configure the enable state of the first configuration item or the values of the configuration variables, updating the display parameter of the first configuration item in the configuration interface of the first configuration item and the display parameters of the corresponding configuration items of the first configuration item in the upper-level configuration interface of the configuration interface of the first configuration item in a first update manner;
when the configuration operation is used to configure the enable state of the first configuration item or the values of the configuration variables, updating the first configuration item to the first configuration interface in a second update manner;
when the configuration operation is used to configure an access path of the first configuration item, updating the display content of the first configuration interface in a third update manner;
when the first configuration item belongs to a first configuration item set, updating the interface content and/or the display parameter of the target configuration interface in a fourth update manner; or
when the first configuration item belongs to a second configuration item set, updating the interface content and/or the display parameter of the target configuration interface in a fifth update manner.

6. The method according to claim 4, wherein updating the display parameter of the target configuration interface includes at least one of:
adding a corresponding display identifier in a first display area of the configuration interface of the first configuration item and a second display area of the upper-level configuration interface of the configuration interface respectively, wherein the display identifier of the first display area is the same as or different from the display identifier of the second display area;
displaying and outputting the first configuration item and/or the second configuration item in the configuration interface of the first configuration item and the upper-level configuration interface of the configuration interface of the first configuration item with character parameters that are different from those of other configuration items;
displaying and outputting the first configuration item and/or the second configuration item in the configuration interface of the first configuration item and the upper-level configuration interface of the configuration interface of the first configuration item with a display output method that is different from that of other configuration items; or
adding corresponding background data in the first display area of the configuration interface of the first configuration item and the second display area of the upper-level configuration interface of the configuration interface, wherein the background data of the first display area and the background data of the second display area are the same as or different from those of the second display area.

7. The method according to claim 1, wherein prompting the configuration item affected by the configuration operation includes:
in response to an operation of switching the current configuration interface of the first configuration item, outputting prompt information of the configuration item that at least reflects the change of the configuration variables in the upper-level configuration interface of the configuration interface of the first configuration item and/or the first configuration interface in a corresponding output manner based on the switching mode.

8. The method according to claim 7, wherein outputting the prompt information of the configuration item that at least reflects the change of the configuration variables in the upper-level configuration interface of the configuration interface of the first configuration item and/or the first configuration interface in the corresponding output manner based on the switching mode, including at least one of:
when the switching mode is to close the current configuration interface, minimizing the current configuration interface, or moving the current configuration interface to a designated display area, and outputting the corresponding prompt information in a manner of outputting the content and/or time of the configuration variable change; or
when the switching mode is to return to the upper-level configuration interface, outputting the corresponding prompt information in a manner of adjusting the display parameter of the configuration item.

9. The method according to claim 1, further including at least one of:
in response to a configuration operation acting on the second configuration item added to the first configuration interface, synchronously updating corresponding configuration variable data changed by the configuration operation in a configuration interface to which the second configuration item belongs, wherein the second configuration item is able to be dragged from the configuration interface to which it belongs to the first configuration interface; or
updating timestamp information of the configuration operation and/or historical configuration data of the first configuration item to a target display area of the target configuration interface.

10. An electronic device, comprising:
one or more processors; and
a memory coupled to the one or more processors and storing program instructions that, when being executed, cause the one or more processors to perform:
in response to a configuration operation acting on a first configuration item of an electronic device,
updating an interface parameter of a target configuration interface of the electronic device to prompt a configuration item acted upon by the configuration operation,
wherein the target configuration interface includes a configuration interface where the first configuration item is located and/or a configuration interface where a second configuration item is located, and the second configuration item is an upper-level configuration item of the first configuration item.

11. The device according to claim 10, wherein the one or more processors are further configured to perform at least one of:
in response to the configuration operation acting on the first configuration item of the electronic device, generating corresponding configuration information, and updating an interface content and/or a display parameter of the target configuration interface based on the configuration information; or
updating the interface content and/or the display parameter of the target configuration interface in a corresponding update manner based on a type of the configuration operation and/or attribute information of the first configuration item, wherein different types of configuration operations correspond to different update manners,
wherein:
the target configuration interface includes at least one of the configuration interface of the first configuration item, the upper-level configuration interface of the configuration interface of the first configuration item, or a first configuration interface; and
the first configuration interface is different from the configuration interface of the first configuration item and the upper-level configuration interface of the configuration interface of the first configuration item.

12. The device according to claim 11, wherein the one or more processors are further configured to perform at least one of:
obtaining target reference data and using the target reference data to compare configuration variables of the first configuration item after the configuration operation, to obtain the configuration information, wherein the target reference data represents initial configuration variables of a configuration item set to which the first configuration item belongs; or
when the configuration operation changes the configuration variables of the first configuration item, generating the configuration information based on the configuration variables input by the configuration operation.

13. The device according to claim 11, wherein the one or more processors are further configured to perform at least one of:
when the configuration information indicates that an enable state of the first configuration item is changed, updating the display parameter of the first configuration item in the configuration interface of the first configuration item and display parameters of corresponding configuration items of the first configuration item in the upper-level configuration interface of the configuration interface of the first configuration item;
when the configuration information indicates that the configuration operation configures an access path of the first configuration item, updating the display content of the first configuration interface;
when the configuration information indicates that values of the configuration variables of the first configuration item are changed, updating the display parameter of the first configuration item in the configuration interface of the first configuration item and display parameters of the corresponding configuration items of the first configuration item in the upper-level configuration interface of the configuration interface of the first configuration item; or
when the configuration information indicates that the enable state of the first configuration item is changed or the values of the configuration variables are changed, updating the first configuration item to the first configuration interface.

14. The device according to claim 11, wherein the one or more processors are further configured to perform at least one of:
when the configuration operation is used to configure the enable state of the first configuration item or the values of the configuration variables, updating the display parameter of the first configuration item in the configuration interface of the first configuration item and the display parameters of the corresponding configuration items of the first configuration item in the upper-level configuration interface of the configuration interface of the first configuration item in a first update manner;
when the configuration operation is used to configure the enable state of the first configuration item or the values of the configuration variables, updating the first configuration item to the first configuration interface in a second update manner;
when the configuration operation is used to configure an access path of the first configuration item, updating the display content of the first configuration interface in a third update manner;
when the first configuration item belongs to a first configuration item set, updating the interface content and/or the display parameter of the target configuration interface in a fourth update manner; or
when the first configuration item belongs to a second configuration item set, updating the interface content and/or the display parameter of the target configuration interface in a fifth update manner.

15. The device according to claim 13, wherein the one or more processors are further configured to perform at least one of:
adding a corresponding display identifier in a first display area of the configuration interface of the first configuration item and a second display area of the upper-level configuration interface of the configuration interface respectively, wherein the display identifier of the first display area is the same as or different from the display identifier of the second display area;
displaying and outputting the first configuration item and/or the second configuration item in the configuration interface of the first configuration item and the upper-level configuration interface of the configuration interface of the first configuration item with character parameters that are different from those of other configuration items;
displaying and outputting the first configuration item and/or the second configuration item in the configuration interface of the first configuration item and the upper-level configuration interface of the configuration interface of the first configuration item with a display output method that is different from that of other configuration items; or
adding corresponding background data in the first display area of the configuration interface of the first configuration item and the second display area of the upper-level configuration interface of the configuration interface, wherein the background data of the first display area and the background data of the second display area are the same as or different from those of the second display area.

16. The device according to claim 10, wherein the one or more processors are further configured to perform:
in response to an operation of switching the current configuration interface of the first configuration item, outputting prompt information of the configuration item that at least reflects the change of the configuration variables in the upper-level configuration interface of the configuration interface of the first configuration item and/or the first configuration interface in a corresponding output manner based on the switching mode.

17. The device according to claim 16, wherein the one or more processors are further configured to perform at least one of:
when the switching mode is to close the current configuration interface, minimizing the current configuration interface or moving the current configuration interface to a designated display area, and outputting the corresponding prompt information in a manner of outputting the content and/or time of the configuration variable change; or
when the switching mode is to return to the upper-level configuration interface, outputting the corresponding prompt information in a manner of adjusting the display parameter of the configuration item.

18. The device according to claim 10, wherein the one or more processors are further configured to perform at least one of:
in response to a configuration operation acting on the second configuration item added to the first configuration interface, synchronously updating corresponding configuration variable data changed by the configuration operation in a configuration interface to which the second configuration item belongs, wherein the second configuration item is able to be dragged from the configuration interface to which it belongs to the first configuration interface; or
updating timestamp information of the configuration operation and/or historical configuration data of the first configuration item to a target display area of the target configuration interface.

19. A non-transitory computer-readable storage medium, containing program instructions that, when being executed, cause at least one processor to perform:
in response to a configuration operation acting on a first configuration item of an electronic device,
updating an interface parameter of a target configuration interface of the electronic device to prompt a configuration item acted upon by the configuration operation,
wherein the target configuration interface includes a configuration interface where the first configuration item is located and/or a configuration interface where a second configuration item is located, and the second configuration item is an upper-level configuration item of the first configuration item.

20. The storage medium according to claim 19, wherein the at least one processor is further configured to perform at least one of:
in response to the configuration operation acting on the first configuration item of the electronic device, generating corresponding configuration information, and updating an interface content and/or a display parameter of the target configuration interface based on the configuration information; or
updating the interface content and/or the display parameter of the target configuration interface in a corresponding update manner based on a type of the configuration operation and/or attribute information of the first configuration item, wherein different types of configuration operations correspond to different update manners, wherein:
the target configuration interface includes at least one of the configuration interface of the first configuration item, the upper-level configuration interface of the configuration interface of the first configuration item, or a first configuration interface; and
the first configuration interface is different from the configuration interface of the first configuration item and the upper-level configuration interface of the configuration interface of the first configuration item.
